(19) United States
(12) Patent Application Publication
(10) Pub. No.: US 2002/0081024 A1
(43) Pub. Date: Jun. 27, 2002

(54) Apparatus and method for retrieving color and shape of image based on natural language

(76) Inventors: Sung Hee Park, Taejon (KR); Hyun Jin Kim, Taejon (KR); Soo Jun Park, Seoul (KR); Myung Gil Jang, Taejon (KR)

Correspondence Address: JACOBSON HOLMAN, PLLC., PROFESSIONAL LIMITED LIABILITY COMPANY, 400 Seventh Street, N.W., Washington, DC, 20004, US

(21) Appl. No.: 10/025,912

(22) Filed: Dec. 26, 2001

(30) Foreign Application Priority Data
Dec. 26, 2000 (KR) 2000-82179

(51) Int. Cl. G06K 9/60

(52) U.S. Cl. 382/165; 382/170; 382/305

(57) ABSTRACT

An apparatus and method for searching color and shape of image data based on a natural language with Fuzzy concept is disclosed. The apparatus for retrieving includes: a dictionary storing unit for storing a dictionary used for processing a natural language; a color/shape threshold storing unit for storing color histograms mapped to color related words and edge information corresponding to shape related words; a query input unit for receiving a query sentence which describes the color and the shape of the image by using a natural language; an analyzing unit for analyzing the query sentence based on the dictionary information and generating analyzed words; a color/shape recognizing unit for recognizing whether the analyzed words represent the color or the shape; a color/shape threshold database constructing unit for mapping and storing color histograms to color related words and storing edge information corresponding to shape related words; a color/shape threshold retrieving unit for retrieving the color histograms and the edge information corresponding to the analyzed words from the color/shape threshold storing unit; and a retrieving result output unit for providing image data searched in the color/shape threshold retrieving unit.

### FIELD OF THE INVENTION

The present invention relates to an apparatus and method for retrieving a color and a shape of an image; and, more particularly, to an apparatus and method for retrieving a color and a shape of an image based on a natural language with Fuzzy concept.

### DESCRIPTION OF RELATED ART

In conventional image retrieval methods, information related to a color and a shape of an image is directly inputted by a user. In the conventional method, the user inputs red, green, blue (RGB) values of the color for the requested image by numerical data or selects the color for the request image in a color palette. The shape of the requested image is directly drawn or an image file having a similar shape as that of the requested image is inputted. The conventional method has an advantage that it is possible for database to keep a small amount of words, however, the inputted to the image retrieval system is limited to the color and the shape. Therefore, a procedure is requested that the color and the shape information of the image should be represented as numerical values in advance.

On the other hand, some conventional image retrieval systems try to retrieve an image based on words related to the color by using the natural language processing. However, in this case, only some words which are designated by the image retrieval system can be used.

In other words, the retrieval technique based on the natural language is frequently used and generalized, however, the natural language processing is applied to only an annotation-based retrieval system. Therefore, the retrieval of the color and shape of the image cannot be performed based on the natural language familiar to the user. It is necessary to provide an image retrieval system which retrieves a color and a shape of an image by analyzing a query sentence including words related the color and the shape of the image (hereinafter, referred to as “color related words” and “shape related words).

### SUMMARY OF THE INVENTION

It is, therefore, an object of the invention to provide an apparatus and method for retrieving a color and a shape of an image by analyzing a query sentence described by a natural language familiar to a user.

In accordance with an aspect of the present invention, there is provided an apparatus for retrieving a color and a shape of an image based on a natural language, including: a dictionary storing unit for storing a dictionary used for processing a natural language; a color/shape threshold storing unit for storing color histograms mapped to color related words and edge information corresponding to shape related words; a query input unit for receiving a query sentence which describes the color and the shape of the image by using a natural language; an analyzing unit for analyzing the query sentence based on the dictionary information and generating analyzed words; a color/shape recognizing unit for recognizing whether the analyzed words represent the color or the shape; a color/shape threshold database constructing unit for mapping color histograms to color related words and storing color histograms corresponding to color related words and storing edge information corresponding to shape related words; a color/shape threshold retrieving unit for retrieving the color histograms and the edge information corresponding to the analyzed words from the color/shape threshold storing unit; and a retrieving result output unit for providing image data searched in the color/shape threshold retrieving unit.

In accordance with another aspect of the present invention, there is provided a method for searching a color and a shape of an image based on a natural language, including the steps of: a) storing dictionary used for processing a natural languages, color histograms mapped to color related words and edge information corresponding to shape related words; b) analyzing a query sentence which describes the color and the shape of the image by using the natural language, based on the dictionary and generating analyzed words; c) recognizing whether the analyzed words represent the color or the shape; d) retrieving the color histograms and the edge information corresponding to the analyzed words from the color/shape threshold storing unit; and e) providing a retrieved image to the user.

In accordance with further another aspect of the present invention, there is provided a computer readable recording medium storing instructions for executing a method for searching a color and a shape of an image based on a natural language, the method comprising the steps of: a) storing dictionary used for processing a natural languages, color histograms mapped to color related words and edge information corresponding to shape related words; b) analyzing a query sentence which describes the color and the shape of the image by using the natural language, based on the dictionary and generating analyzed words; c) recognizing whether the analyzed words represent the color or the shape; d) retrieving the color histograms and the edge information corresponding to the analyzed words from the color/shape threshold storing unit; and e) providing a retrieved image to the user.

### BRIEF DESCRIPTION OF THE DRAWINGS

Other objects and aspects of the invention will become apparent from the following description of the embodiments with reference to the accompanying drawings, in which:

FIG. 1 is a diagram of an image retrieval system for retrieving a color and a shape of an image based on a natural language in accordance with the present invention;

FIG. 2 is a flow chart illustrating a method for retrieving a color and a shape of an image based on a natural language in accordance with the present invention; and

FIG. 3 is a diagram showing data flow in accordance with the present invention.

### DETAILED DESCRIPTION OF THE INVENTION

In an image retrieval system in accordance with the present invention, fuzzy representative threshold values for colors and shapes are registered along with a natural language, if a user inputs a query described by the natural language, the image retrieval system analyzes the query, retrieves an image and outputs a retrieval result to the user. In other words, by adding a natural language processing function to the conventional image retrieving system processing the color and the shape of the image through an interactive input, the image retrieval system in accordance with the present invention provides a user with a convenient image retrieval system.

In order to process not only simple nouns but also complex of the color and the shape described by the natural language, the present invention can be applied to a simple sentence including qualification words.

For example, in order to process “red car”, the natural language processing for recognizing that “red” is a qualified word” is performed and an RGB threshold representing “red” is extracted from the database. Also, “car” is recognized as the shape information and edge information is extracted along with the color information from the database, and then a requested image is retrieved.

Hereinafter, an image retrieval system according to the present invention will be described in detail referring to the accompanying drawings.

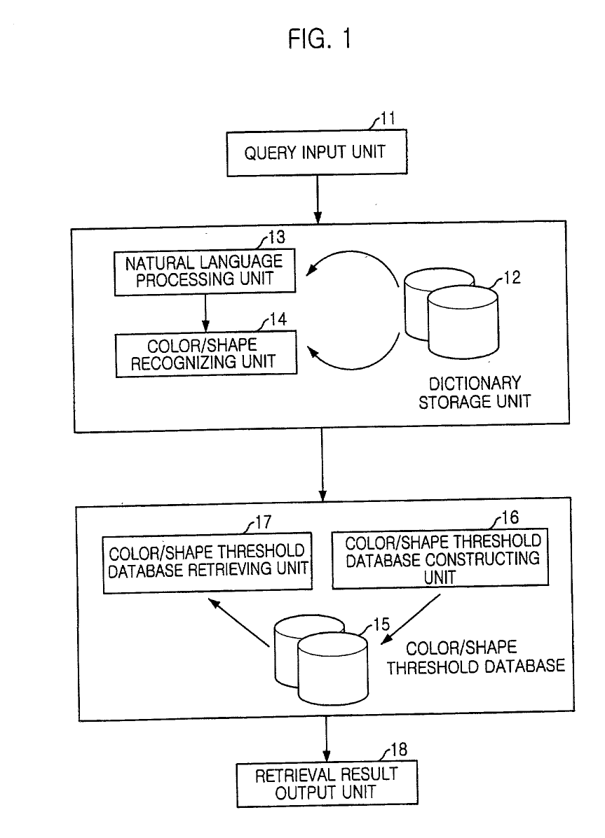

FIG. 1 is a diagram of an image retrieval system for retrieving a color and a shape of an image based on a natural language in accordance with the present invention.

Referring to FIG. 1, an image retrieval system, which retrieves a color and a shape of an image based on natural a language, includes a query input unit 11, a dictionary storage unit 12, a natural language processing unit 13, a color/shape recognizing unit 14, a color/shape threshold database 15, a color/shape threshold database constructing unit 16, a color/shape threshold database retrieving unit 17 and a retrieval result output unit 18.

The query input unit 11 receives a query sentence in which a color and a shape of a requested image are described by the natural language, from a user.

The dictionary storage unit 12 stores a dictionary used for a natural language processing.

The natural language processing unit 13 analyzes the query sentence based on the dictionary stored on the dictionary storage unit 12.

The color/shape recognizing unit 14 recognizes that the analyzed words represent the color or the shape of the image.

The color/shape threshold database 15 stores color histograms mapped to color related words and edge information corresponding to shape related words.

The color/shape threshold database constructing unit 16 maps the color related word to a color histogram and stores the color histogram mapped to the color related word onto the color/shape threshold database 15.

The color/shape threshold retrieving unit 17 retrieves an image satisfying the color and the shape of the analyzed words received from the color/shape threshold database 15.

The retrieval result output unit 18 provides the retrieval result searched in the color/shape threshold retrieving unit 17 to the user.

Hereinafter, principle elements of the image retrieval system based on the natural language will be described in detail.

The natural language processing unit 13 receives the query sentence in which the color and the shape of the requested image to be retrieved are described through the query input unit 11, separates the query sentence into words and analyzes the words. Accordingly, the natural language processing unit 13 includes a tokenizer for separating the query sentence by a phrase, a dictionary retrieval unit for retrieving the dictionary and finding morphemes of the word outputted from the tokenizer, and a parser for recognizing the sentence structure.

The color/shape recognizing unit 14 receives a result list from the natural language processing unit 13, and classifies and recognizes the words as the color related words and the shape related words. Also, the color/shape recognizing unit 14 automatically recognizes conditions based on qualifying relation analyzed in the parser or extra patterns.

The color/shape threshold database constructing unit 16 stores the color related information and the shape related information, and the color/shape threshold retrieving unit 17 retrieves an image satisfying the color and the shape of the analyzed words. In other words, the color/shape threshold database 15 is constructed by storing threshold values of the color related information and the shape related information of the image by color/shape threshold database constructing unit 16, and retrieved by the color/shape threshold retrieving unit 17.

In the color query, the color histogram or the color histogram along with the color related word is stored. In case of the word representing the color, e.g., green, blue or red, the word is mapped to the color histogram and then the color histogram is stored. In case of the word not representing the color but reminding the color (i.e., the color related word), e.g., maple, sea, or glow, the words are stored along with the color histogram corresponding to the word.

In the shape query, edge information corresponding to a word having a figure is stored.

In storing the color information, there are two cases, i.e., a default color palette and a user-defined palette. In case of the default color palette, a word and a threshold are mapped to each of 256 colors and stored. In case of user-defined palette, a color is selected from the palette by the user, a word corresponding to the color is inputted by the user and stored, and then the word inputted by the user is automatically retrieved.

In storing the shape information, there are two types, i.e., a default type and a user-defined type. In a default type, shapes frequently used are generalized and stored along with corresponding words and edge information. In a user-defined type, edge information of a requested shape which the user wants to retrieve is directly inputted by drawing or loading a file and stored along with a corresponding word.

The retrieval result output unit 18 provides the retrieval result to the user.

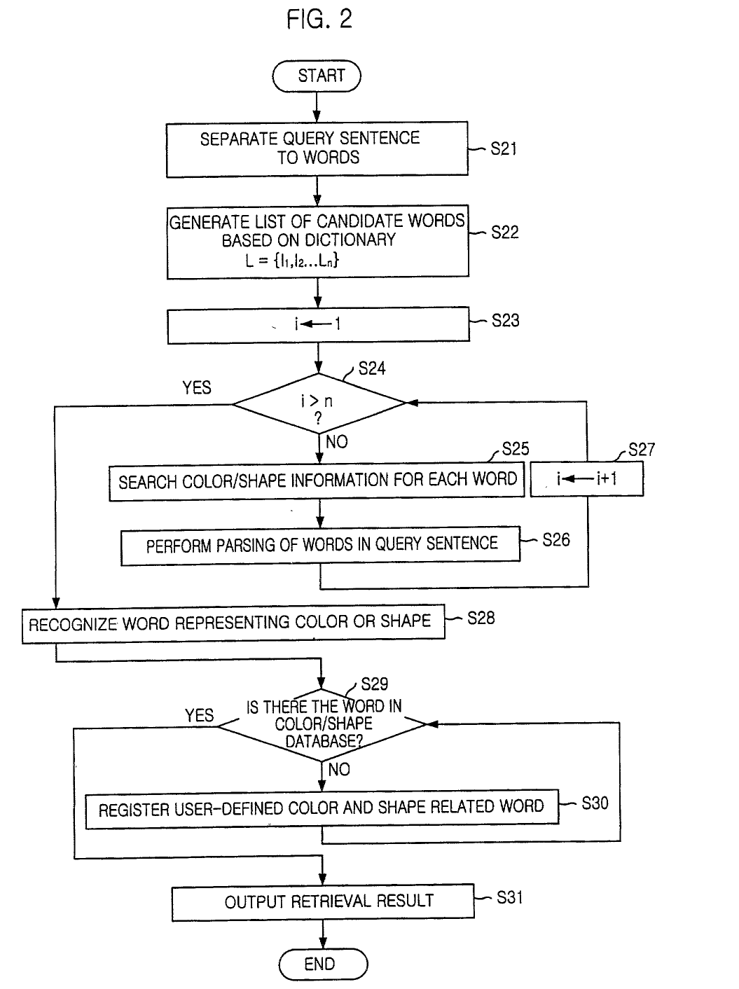

FIG. 2 is a flow chart illustrating a method for retrieving a color and a shape of an image based on a natural language in accordance with the present invention.

The image retrieval method will be described by taking a case as an example that the user inputs “strongly red color” as the query.

First, if the user inputs the query sentence represented by the natural language such as “strongly red color”, the natural language processing unit 13 separates the query sentence into three words [strongly], [red] and [color] at step S21.

The dictionary retrieval unit retrieves [strongly-(adverb)], [red-(adjective)] and [color-(noun)] through the dictionary storage unit and generate a list having n candidate words at step 22.

Next, retrieving the color/shape information for the candidate words and parsing of the words are iteratively performed at steps S23 to S27. At this time, the parser analyzes relations that the adverb [strongly] qualifies the adjective [red], [strongly red] qualifies the noun [color].

The color/shape recognizing unit 14 recognizes the color related word or the shape related word among input words by means of the adjectives and the nouns at step S28.

The parser recognizes [red] which is analyzed as an adjective, [color] which is analyzed as a noun and [strongly] which is analyzed as an adverb emphasizing a qualified word.

The color/shape threshold retrieving unit 17 retrieves the color/shape database 15 and find threshold of [red], for example, the color histogram, and increases lightness and chroma of the threshold representing red in order to process the adverb [strongly] at step S29.

Then, the retrieval result output unit 18 outputs the retrieved image to the user at step S30.

If there is no threshold of the requested image in the color/shape database 15, the user registers color/shape information in the color/shape database and retrieves the image at step S31.

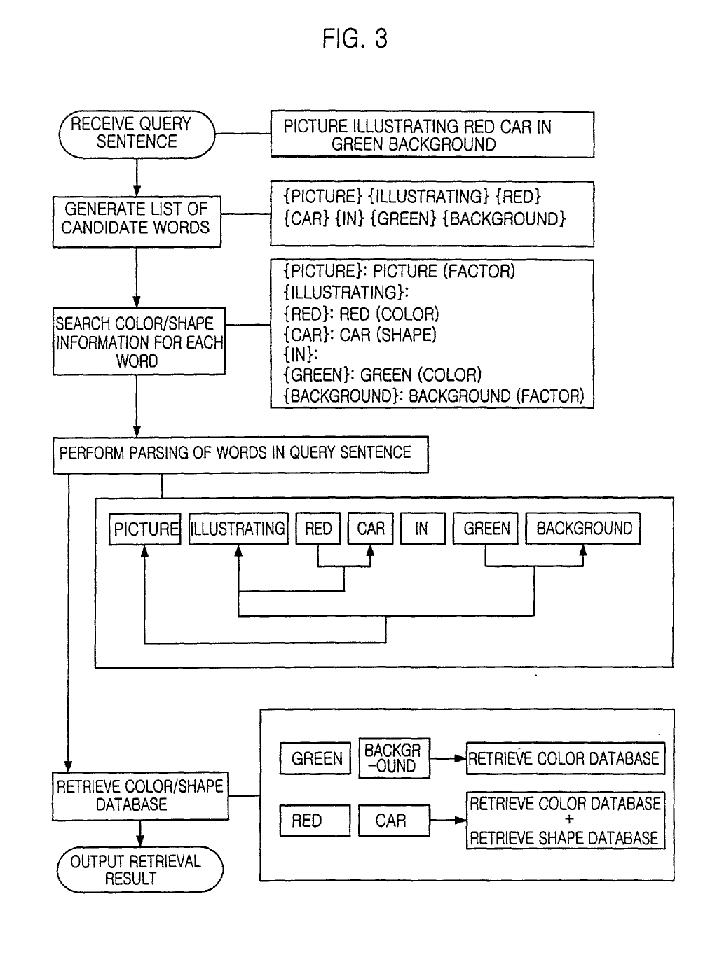

FIG. 3 is a diagram showing data flow in accordance with the present invention.

Referring to FIG. 3, if a sentence “a picture illustrating a red car in a green background” is inputted, a list having candidate words, i.e., {picture}, {illustrating}, {red}, {car}, {in+green} and (background).

In the color/shape retrieval procedure, {picture (image) (factor)}, {illustrating}, {red (color)}, {car (shape)}, {in+green (color)} and {background (factor)} are searched.

In parsing procedure, it is recognized that {green} qualifies {background}, {red} qualifies {car}, {illustrating red car in green background} qualifies {picture}.

In the retrieval of the color/shape database, “green” and “background” are searched in the color database, and “red” and “car” are searched in the color database and the shape database.

Last, the retrieval result is outputted to the user.

The method described above can be embodied as programs and stored to computer readable recording medium, for example, a CDROM, a RAM, a ROM, a floppy disk, a hard disk, a magneto-optic disk, etc.

In the present invention, by registering fuzzy representative values for the colors and the shapes along with the words expressed by the natural language, when the query sentence expressed by natural language familiar to the user, the query sentence is analyzed and retrieved, thereby enhancing the image retrieval system.

By adding a function of processing the natural language for the color and the shape, the image retrieval system makes the user feel much more comfortable in retrieving the image.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for retrieving a color and a shape of an image based on a natural language, comprising:
a dictionary storing means for storing a dictionary used for processing a natural language;
a color/shape threshold storing means for storing color histograms mapped to color related words and edge information corresponding to shape related words;
a query input means for receiving a query sentence which describes the color and the shape of the image by using a natural language;
an analyzing means for analyzing the query sentence based on the dictionary information and generating analyzed words;
a color/shape recognizing means for recognizing whether the analyzed words represent the color or the shape;
a color/shape threshold database constructing means for mapping and storing color histograms to color related words and storing edge information corresponding to shape related words;
a color/shape threshold retrieving means for retrieving the color histograms and the edge information corresponding to the analyzed words from the color/shape threshold storing means; and
a retrieving result output means for providing image data searched in the color/shape threshold retrieving means.

2. The apparatus as recited in claim 1, wherein if there is no color histogram and edge information satisfying requirement for the analyzed words, the color/shape threshold database constructing means receives threshold of the color and the shape from the user and stores the thresholds into the color/shape storing means.

3. The apparatus as recited in claim 1, wherein the color/shape threshold constructing means maps the word representing the color to the color histogram, and stores the word representing the color mapped to the color histogram, the word not representing the color but reminding the color along with the corresponding color histogram and the edge information corresponding to the shape related word.

4. The apparatus as recited in claim 3, wherein the color/shape recognizing means automatically recognizes requirements based on qualification relation and patterns analyzed in the natural language processing means.

5. A method for searching a color and a shape of an image based on a natural language, comprising the steps of:
a) storing dictionary used for processing a natural languages, color histograms mapped to color related words and edge information corresponding to shape related words;
b) analyzing a query sentence which describes the color and the shape of the image by using the natural language, based on the dictionary and generating analyzed words;
c) recognizing whether the analyzed words represent the color or the shape;
d) retrieving the color histograms and the edge information corresponding to the analyzed words from the color/shape threshold storing means; and
e) providing a retrieved image to the user.

6. The method as recited in claim 5, further comprising the step of:
f) if there is no color histogram and edge information satisfying requirement for the analyzed words, receiving and storing thresholds of the color and the shape from the user.

7. A computer readable recording medium storing instructions for executing a method for searching a color and a shape of an image based on a natural language, the method comprising the steps of:
a) storing dictionary used for processing a natural languages, color histograms mapped to color related words and edge information corresponding to shape related words;
b) analyzing a query sentence which describes the color and the shape of the image by using the natural language, based on the dictionary and generating analyzed words;
c) recognizing whether the analyzed words represent the color or the shape;
d) retrieving the color histograms and the edge information corresponding to the analyzed words from the color/shape threshold storing means; and
e) providing a retrieved image to the user.

8. The computer readable recording medium as recited in claim 7, further comprising the step of:
f) if there is no color histogram and edge information satisfying requirement for the analyzed words, receiving and storing thresholds of the color and the shape from the user.
